(19) United States
(12) Patent Application Publication
(10) Pub. No.: US 2025/0293499 A1
(43) Pub. Date: Sep. 18, 2025

(54) UNIVERSAL BACK MOUNTING PLATE

(71) Applicant: Hubbell Incorporated, Shelton, CT (US)

(72) Inventors: Krzysztof W. Korcz, Granger, IN (US); Victor Beristany, South Bend, IN (US); Krishna C. Patel, Granger, IN (US)

(21) Appl. No.: 19/078,447

(22) Filed: Mar. 13, 2025

Related U.S. Application Data
(60) Provisional application No. 63/565,836, filed on Mar. 15, 2024.

(51) Int. Cl. H02G 3/12

(52) U.S. Cl. CPC H02G 3/12

(57) ABSTRACT

A mounting bracket that includes a body, a first tab, and a second tab. The body has an inner perimeter and an outer perimeter. The first tab extends from the body in a first direction. The first tab includes a first slot configured to receive a first fastener. The second tab extends from the body in a second direction opposite the first direction. The second tab includes a second slot that can receive a second fastener. The first tab and the second tab are each movable relative to the body between a first position and a second position. The first position is substantially parallel to the surface of the body and the second position is substantially perpendicular to the surface of the body.

### CROSS-REFERENCE TO RELATED APPLICATION

This application claims the benefit of U.S. Provisional Application No. 63/565,836, filed Mar. 15, 2024, the entire contents of which is incorporated herein by reference in its entirety.

### FIELD

The present disclosure relates to a mounting plate. More particularly, the present disclosure relates to a mounting plate that can connect to a variety of sized electrical boxes and mount to supports from behind.

### BACKGROUND

Electrical boxes may be mounted in ceiling or walls between a pair of rails that extend between braces. Specifically, a mounting plate may be used to connect the electrical box to the pair of rails. When mounted, the electrical box is generally positioned behind the rails while the mounting plate is positioned in front of the rails.

Technicians may find it easier to connect the mounting plate to the electrical box prior to connecting the mounting plate to the rails. However, the size of the electrical box and/or the mounting plate may limit connection in this order. For example, larger electrical boxes may be too large to fit through the opening between a pair of rails. Additionally, wires or other electrical components may extend from the box and make passing the electrical box through the opening impracticable. Being able to mount the mounting bracket to the rails from behind so that the electrical box does not pass through the opening would minimize this impracticability.

### SUMMARY

Various examples of the present disclosure can overcome various of the aforementioned and other disadvantages associated with known mounting plates and offer new advantages as well.

According to one aspect of various examples of the present disclosure there is provided a universal mounting plate than can connect to a plurality of different-sized electrical boxes.

According to one aspect of various examples of the present disclosure there is provided a mounting plate that includes a movable tab to permit passage through a space between a pair of rails.

According to another aspect of various examples of the present disclosure, there is provided a mounting bracket that includes a body, a first tab, and a second tab. The body has an inner perimeter and an outer perimeter. The first tab extends from the body in a first direction. The first tab includes a first slot configured to receive a first fastener. The second tab extends from the body in a second direction opposite the first direction. The second tab includes a second slot that can receive a second fastener. The first tab and the second tab are each movable relative to the body between a first position and a second position. The first position is substantially parallel to the surface of the body and the second position is substantially perpendicular to the surface of the body.

According to another aspect of various examples of the present disclosure, there is provided a mounting system that includes an electrical box and a mounting plate that is selectively connected to the electrical box. The mounting plate can support the electrical box between a pair of rails. The mounting plate includes a body, a first tab, and a second tab. The body has an inner perimeter and an outer perimeter. The first tab extends from the body in a first direction. The first tab includes a first slot configured to receive a first fastener. The second tab extends from the body in a second direction opposite the first direction. The second tab includes a second slot that can receive a second fastener. The first tab and the second tab are each movable relative to the body between a first position and a second position. The first position is substantially parallel to the surface of the body and the second position is substantially perpendicular to the surface of the body.

According to another aspect of various examples of the present disclosure, there is provided a mounting system that includes a body, a first tab, and a first hook. The body has an inner perimeter and an outer perimeter. The first tab extends from the body in a first direction. The first tab includes a first slot that can receive a first fastener. The first hook is offset from the first tab in a second direction perpendicular to the first direction. The first hook and the first tab are spaced apart by a first distance in a third direction that is perpendicular to the first direction and the second direction. The first tab is movable relative to the body between a first position and a second position. The first position is substantially parallel to the surface of the body and the second position is substantially perpendicular to the surface of the body.

According to another aspect of various examples of the present disclosure, there is provided a method of connecting a mounting plate to a pair of rails from behind the pair of rails.

According to another aspect of various examples of the present disclosure, there is provided a method of mounting an electrical box between a pair of rails, the method including: connecting a mounting plate to the electrical box, the mounting plate including a first edge having a first tab and a first hook, and a second edge having a second tab and a second hook, wherein the first edge is opposite the second edge; bending the first tab from a first position to a second position substantially perpendicular to the first position; positioning the mounting plate behind the pair of rails and moving the second edge at least partially through an opening between the pair of rails; while the second tab and second hook contract one rail of the pair of rails, pivoting the first edge at least partially through the opening; and moving the first tab to the first position to contact the other rail of the pair of rails.

According to another aspect of various examples of the present disclosure, there is provided method of mounting an electrical box between a pair of rails. The method includes selecting an electrical box between a first electrical box and a second electrical body. The first electrical box has a first width and the second electrical box has a second width that is greater than the first width. The method also includes connecting a mounting plate to the selected one of the first electrical box and the second electrical box. The mounting plate includes a first edge having a first tab and a first hook, and a second edge having a second tab and a second hook. The first edge is opposite the second edge. The method further includes bending the first tab from a first position to a second position. The first tab is entirely coplanar with the second tab in the first position, and the first tab moves at least partially out of plane with the second tab in the second position. The method also includes positioning the mounting plate behind the pair of rails and moving the second edge at least partially through an opening between the pair of rails. The method further includes pivoting the first edge at least partially through the opening while the second tab and second hook contract one rail of the pair of rails. Finally, the method includes moving the first tab to the first position to contact the other rail of the pair of rails.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompany drawing wherein:

FIG. 1 is a perspective view of a mounting plate with mounting tabs in a first position.

FIG. 2 is a top view of the mounting plate of FIG. 1.

FIG. 3 is a side view of the mounting plate of FIG. 1.

FIG. 4 is a front view of the mounting plate of FIG. 1.

FIG. 5 is a detail view of the mounting plate of FIG. 1 with the mounting tabs in a second position.

FIG. 6 is a perspective view of the mounting plate of FIG. 1 mounted to a first electrical box.

FIG. 7 is a perspective view of the mounting plate of FIG. 1 mounted to a second electrical box.

FIG. 8 is a perspective view of the mounting plate of FIG. 1 mounted to a third electrical box.

FIG. 9 is a cross-sectional view of a first step of mounting the mounting plate to a brace.

FIG. 10 is a cross-sectional view of a second step of mounting the mounting plate to the brace.

FIG. 11 is a cross-sectional view of a third step of mounting the mounting plate to a brace.

FIG. 12 is a perspective view of the mounting plate mounted between a pair of braces.

FIG. 13 is a perspective view of multiple mounting plates mounted between a pair of braces.

### DETAILED DESCRIPTION

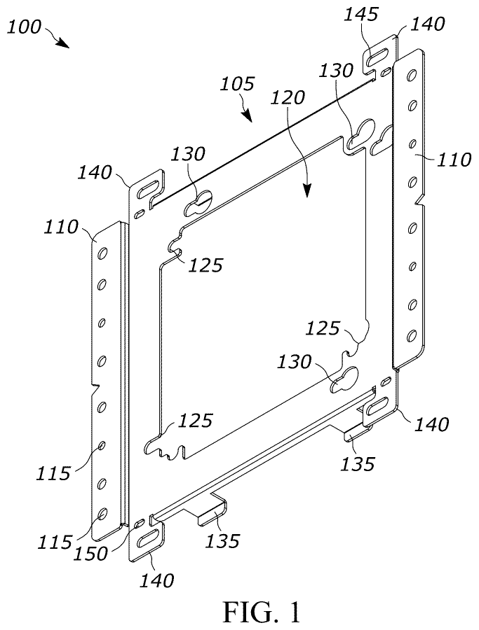

FIGS. 1 to 5 illustrate a mounting bracket 100 that may be used to connect an electrical box 50 to a pair of braces 25. As described in more detail below, the mounting bracket 100 may be used to mount from behind the braces 25.

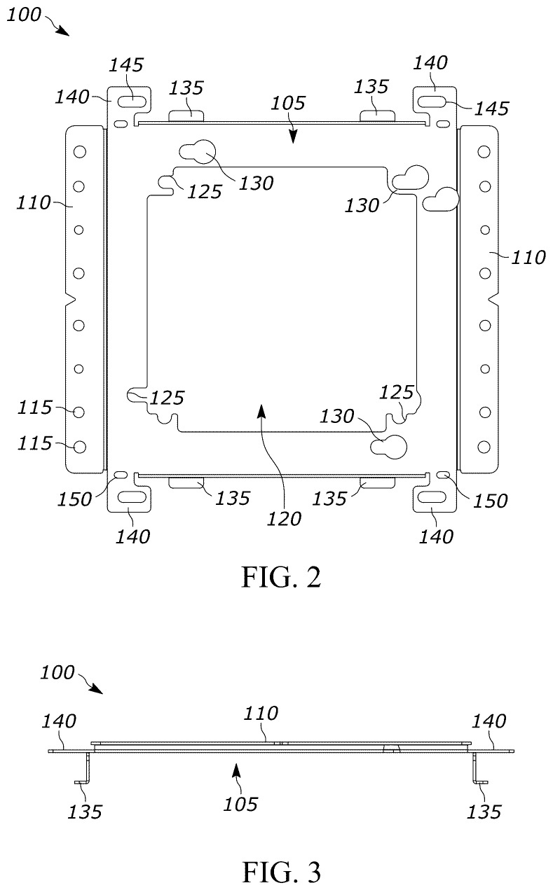

As shown in FIGS. 1 and 2, the mounting bracket 100 may include a body 105 with an outer perimeter. The illustrated outer perimeter may be substantially rectangular in shape, although other examples may include other shapes (e.g., circular, elliptical, etc.).

In some forms, a pair of wings 110 may extend from either side of the body 105. The illustrated wings 110 may be formed as stepped surfaces from the body 105. For example, the wings 110 may be formed on a plane that is offset from the body 105 and parallel to the body 105.

Certain forms of the wings 110 may include one or more apertures 115. The illustrated wings 110 each include eight apertures 115 with substantially equal spacing, although any number of apertures 115 and any spacing may be used. As described in more detail below, the apertures 115 may receive a fastener.

With continued reference to FIGS. 1 and 2, the body 105 includes an inner opening 120 that is formed within the outer perimeter of the body 105. The perimeter of the opening 120 may have a substantially rectangular shape, although any shape may be used (e.g., circular, elliptical, triangular, etc.).

In some forms, one or more mounting features 125 may be formed along the perimeter of the opening 120. For example, the illustrated mounting bracket 100 may include three mounting features 125, although any number may be included. The mounting features 125 may be formed proximate to corners of the opening 120.

The mounting features 125 may be formed with a curved shape with an at least partially open perimeter. For example, one or more of the mounting features 125 may be a semi-circular or semi-elliptical shape. The width of the mounting feature 125 may be sized and shaped to receive a fastener (e.g., a threaded screw).

In some forms, holes 130 may be formed in the body 105 in the area between the outer perimeter and the inner perimeter (e.g., the perimeter of the opening 120). The illustrated holes 130 may be proximate to the mounting features 125. For example, one or more mounting features 125 and one or more holes 130 may be formed proximate to a corner of the opening 120.

In some forms, each hole 130 may have a closed perimeter within the body 105. The perimeter of the hole 130 may be at least partially curved (e.g., circular. Semi-circular, elliptical, semi-elliptical, etc.). In the illustrated example, each hole 130 may include a first width and a second width that is greater than the first width.

The mounting bracket 100 of FIGS. 1 and 2 may also include one or more hooks 135. In the illustrated example, the mounting bracket 100 includes four hooks 135, with two hooks 135 arranged on each side of the body 105 that extends between the wings 110. As shown in FIG. 2, the hooks 135 may include the same spacing on either side of the body 105 and may be aligned with one another across the body 105. Although in other examples, any number of hooks 135 and/or any orientation and position on the body 105 may be used.

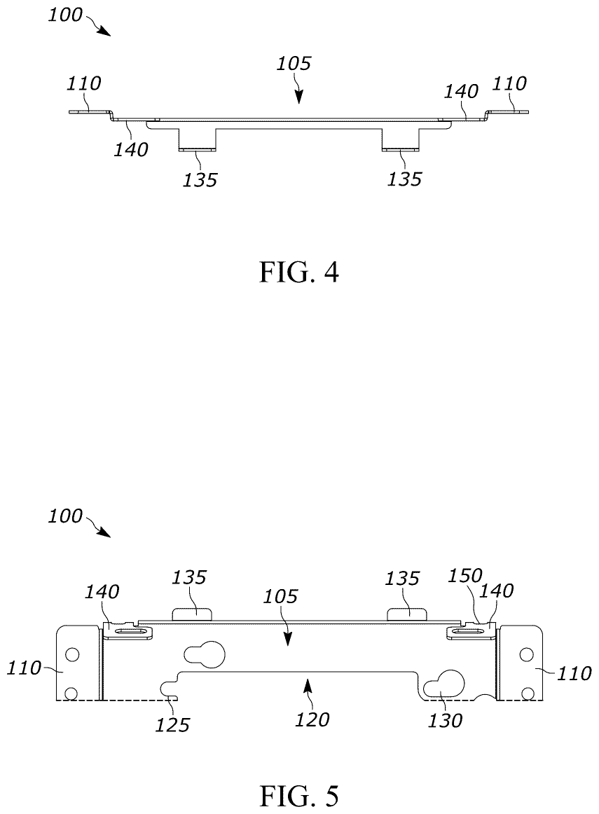

In some forms, each hook 135 may be formed as a cantilever member that extends from the body 105. A fixed end may be disponed on an underside of the body 105 and extend in an opposite direction as the wings 110 (see e.g., FIGS. 3 and 4).

The hook feature formed at the free end of the hook 135 may extend toward the outer perimeter of the body 105 and away from a center of the opening 120. As shown in FIG. 2, the free end of the hook 135 may extend radially outside of the outer perimeter of the body 105.

The mounting bracket 100 of FIGS. 1 and 2 may also include one or more tabs 140 (e.g., cantilever tabs). In the illustrated example, the mounting bracket 100 includes four tabs 140, with two tabs 140 arranged on each side of the body 105 that extends between the wings 110. As shown in FIG. 2, the tabs 140 may include the same spacing on either side of the body 105 and may be aligned with one another across the body 105. Although in other examples, any number of tabs 140 and/or any orientation and position on the body 105 may be used.

As shown in FIG. 2, each tab 140 may be disposed proximate to a wing 110 so that both hooks 135 on a given side of the body 105 are formed between the tabs 140 on the same side. However, other examples may include different orientations (e.g., both tabs 140 between the hooks 135, alternating tab 140 and hook 135, etc.).

With continued reference to FIG. 2, each tab 140 may include a slot 145. The illustrated slot 145 is an elongated although any shape may be used. A width of the slot 145 may be sufficient to permit the slot 145 to receive a fastener.

In some forms, a gap 150 may be formed between the body 105 and each tab 140. The gap 150 may extend partially across a transition between the body 105 and the respective tab 140. As described in more detail below, the gap 150 may act as a hinge to permit movement of the respective tab 140.

With continued reference to FIG. 2, the tabs 140 may be oriented in a first position where the tabs 140 extend parallel to the surface of the body 105 (e.g., the tabs 140 and the body 105 are oriented on the same plane). In this position, the tabs 140 extend away from a center of the body 105 so that a free end of each tab 140 is radially outside of the outer perimeter of the body 105.

Each tab 140 may be moved to a second position independently of the other tabs 140. As shown in FIG. 5, one or more tabs 140 (e.g., two shown) may move to a second position. For example, a technician may bend the tab 140 about the gap 150 to a position substantially perpendicular to the first position. A tab 140 in the second position may be substantially parallel to the hooks 135 and may extend in the opposite direction as the hooks 135.

Each tab 140 bent into the second position may be able to return to the first position. For example, a technician may bend the tab 140 in the opposite direction about the gap 150 to return the tab to the first position. In the illustrate example, each tab 140 may remain in its selected position until acted on by an outside force (e.g., the technician).

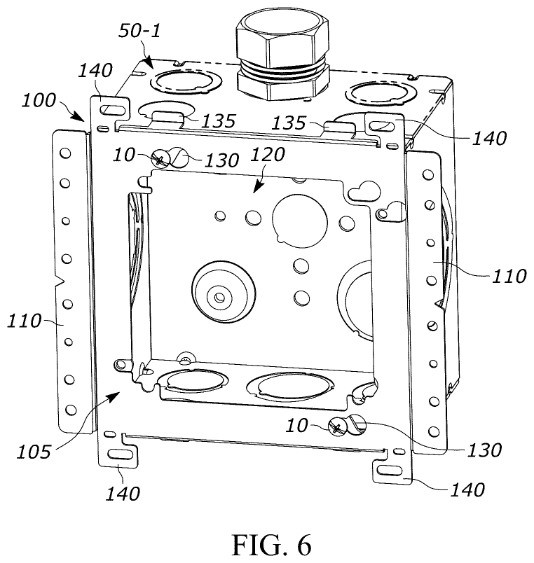

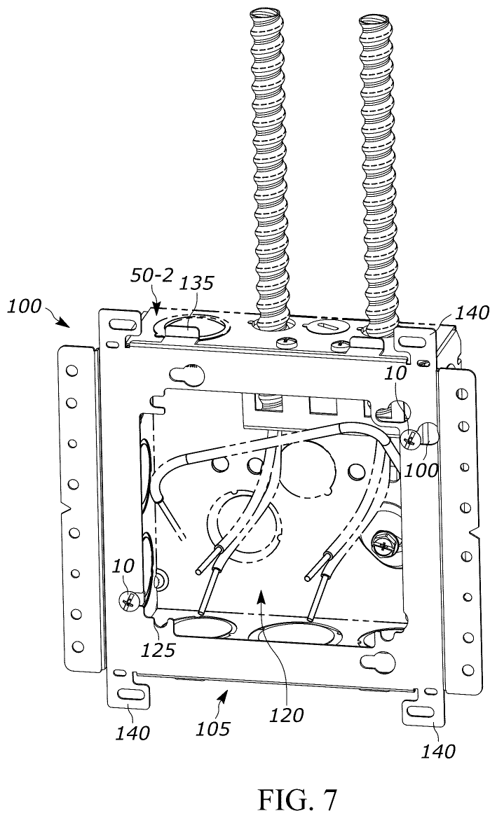

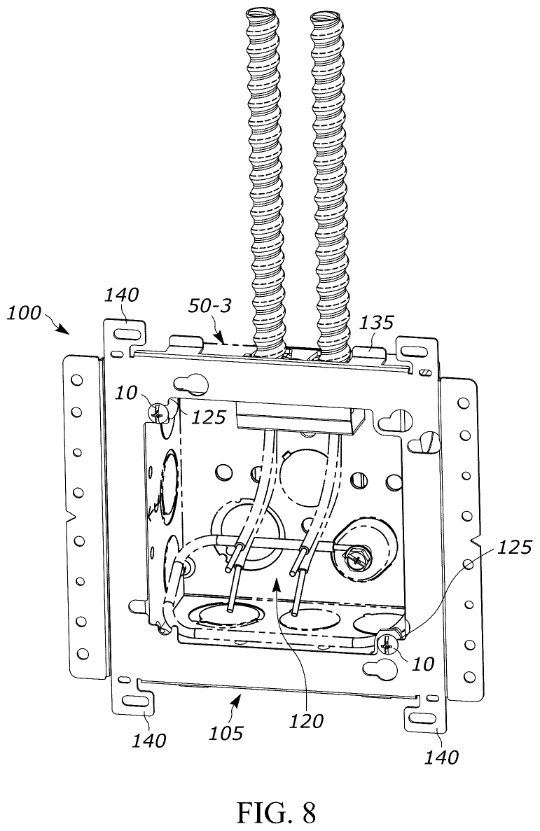

As shown in FIGS. 6 to 8, the mounting bracket 100 may be connected to one of multiple electrical boxes 50. The different electrical boxes 50 may have at least one different dimension (e.g., a different length, width, and/or height). For example, FIG. 6 may illustrate a 5-inch square box 50-1, FIG. 7 may illustrate a 4 11/16-inch square box 50-2, and FIG. 8 may illustrate a 4-inch square box 50-3. Differently sized electrical boxes 50 may be selected based on different requirements (e.g., size of components housed in the electrical box 50). The same mounting bracket 100 may be connected to any of the selected boxes 50.

The positioning of the mounting features 125 and holes 130 may permit the same mounting bracket 100 to be used with the different-sized electrical boxes 50. For example, fasteners 10 may be inserted through the holes 130 to connect the mounting bracket 100 to electrical box 50-1. To connect to box 50-2, one fastener 10 may be inserted through a hole 130 and one may be inserted through a mounting feature 125. To connect to box 50-3, both fasteners 10 may be inserted through the mounting features 125. Using different combinations of mounting features 125 and holes 130 creates different spacing between the fasteners 10 and allows the fasteners to reach differently position holes (not shown) in each electrical box 50. In other words, boxes of different sizes have different hole positions, so using differently spaced mounting features 125 and holes 130 permits connection to each.

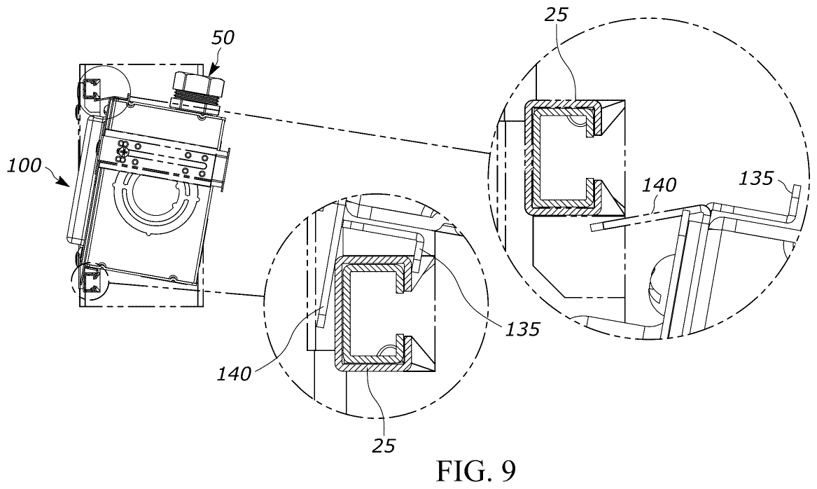

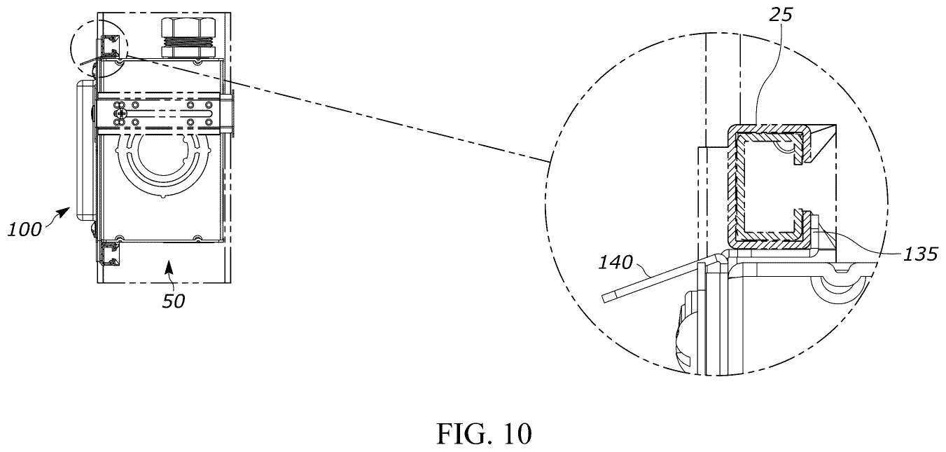

FIGS. 9 to 11 illustrate a method of connecting an electrical box 50 to the rails 25 using the mounting bracket 100. The 5-inch square box 50-1 is illustrated in these figures. However, the steps to connect electrical boxes 50 of other sizes using the mounting bracket 100 would be substantially the same and thus are not repeated for the sake of brevity. These steps permit the mounting bracket 100 to connect to the rails 25 from behind. This may simplify the mounting process because conductors or other elements that pass out of the electrical box 50 do not need to pass around the rails 25. In this way, the electrical components may be pre-installed within the electrical box 50, and then the electrical box 50 can be mounted on the rails 25.

FIG. 9 illustrates a first step to connect the mounting bracket 100 to the rails 25. The width of the body 105 may be approximately the distance between the rails 25. In other words, the mounting bracket 100 may be too wide to fit through the space between the rails 25 when the tabs 140 are in the first position. To accommodate the mounting bracket 100 through this space, the tabs 140 on one side of the body 105 may be bent into the second position. The illustrated example shows the second position more than about 90 degrees from the first position, although any second position that permits the insertion through the rail opening is permitted.

The electrical box 50 may be positioned behind the rails 25 and moved toward the rails 25 at an angle. Specifically, the electrical box 50 may be positioned so that the tabs 140 that remained in the first position are closer to the rails 25.

In some forms, the tabs 140 in the first position may be inserted through the opening and at least partially positioned against a top side of the rail 25. The hooks 135 on the same side of the body 105 may contact the lower side of the same rail 25. The vertical spacing between the hook 135 and the tab 140 in the first position (see e.g., FIG. 4) may be approximately the width of the rail 25.

The tabs 140 on the other side of the body 105 that are in the second position may be able to fit between the rails 25. In other words, moving the tabs 140 on one side to the second position decreased the overall width of the mounting bracket 100 and permits the mounting bracket to fit between the rails 25.

As shown in FIG. 10, the electrical box 50 may be moved so that the upper face of the mounting bracket 100 is positioned through the space between the rails 25. For example, the tabs 140 that remained in the first position may sit flat against the top surface of the rail 25 and the hooks 135 on the same side may sit flat against the bottom surface of the same rail 25. Because the distance between the tabs 140 and hooks 135 is substantially equal to the height of the rail 25, the tabs 140 and hooks 135 may limit relative movement between the mounting bracket 100 and the rail 25 in the vertical direction (e.g., perpendicular to the rail 25).

With continued reference to FIG. 10, the tabs 140 on the opposite side of the body 105 may remain in the second position so that the mounting bracket 100 could fit completely through the space between the rails 25. The hooks 135 on that side of the body 105 may contact the bottom surface of the rail 25. The hooks 135 may act as a stop to limit the mounting bracket 100 from moving further through the opening between the rails 25.

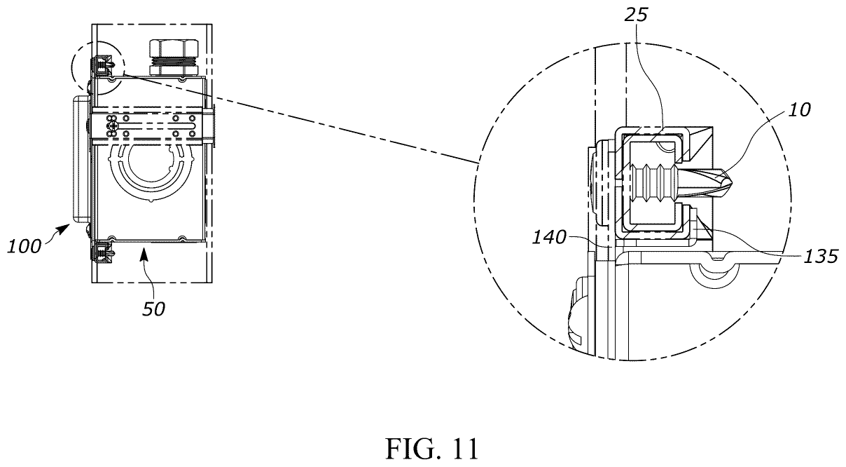

As shown in FIG. 11, the tabs 140 in the second position may be moved back to the first position so that they contact the upper surface of the proximate rail 25. In this position, the respective hooks 135 and tabs 140 on either side of the body 105 may contact the upper and lower sides of the respective rails 25. The hooks 135 and tabs 140 may limit movement of the mounting bracket 100 in a direction perpendicular to the rails 25 but may not limit movement along the length of the rails 25. For example, the technician may move (e.g., slide) the mounting bracket 100 (and therefore the electrical box 105) along the length of the rails 25 to a desired position.

Once the mounting bracket 100 is in the desired position, fasteners 10 may be inserted through one or more of the slots 145 to secure the mounting bracket 100 in position relative to the rails 25. The mounting bracket 100 may then be mounted to the rails 25.

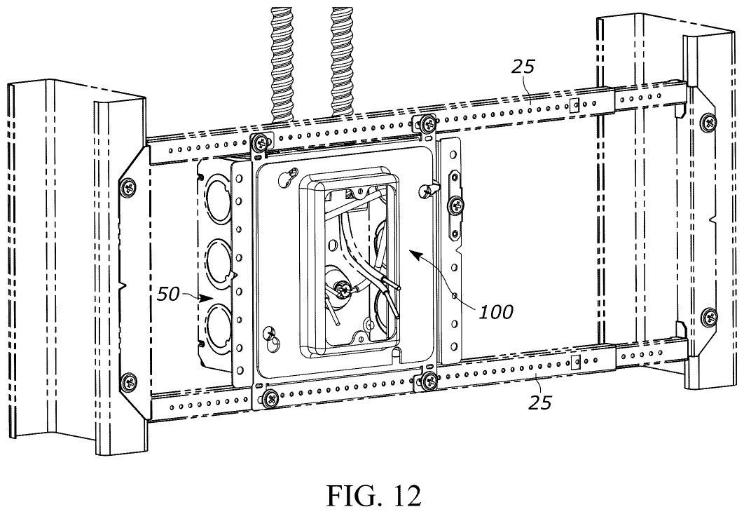

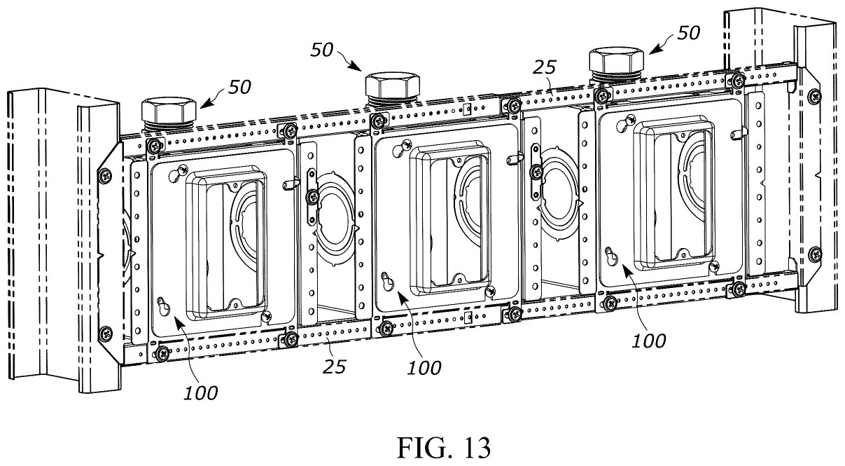

As shown in FIGS. 12 and 13, any number of mounting brackets 100 may be connected along a length of the rails 25. For example, FIG. 12 illustrates a single mounting bracket 100 and electrical box 50, while FIG. 13 illustrates three mounting bracket 100 and electrical box 50 pairs.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. A mounting bracket comprising:
a body having an inner perimeter and an outer perimeter;
a first tab extending from the body in a first direction, the first tab including a first slot configured to receive a first fastener; and
a second tab extending from the body in a second direction opposite the first direction, the second tab including a second slot configured to receive a second fastener;
wherein the first tab and the second tab are each movable relative to the body between a first position and a second position, the first position being substantially parallel to the surface of the body and the second position being substantially perpendicular to the surface of the body.

2. The mounting bracket of claim 1, further comprising:
a first hook offset from the first tab in a third direction perpendicular to the first direction and the second direction; and
a second hook offset from the second tab in the third direction;
wherein the first hook and the first tab are spaced apart by a first distance in a fourth direction that is perpendicular to the first direction and the third direction;
wherein the second hook and the second tab are spaced apart by the first distance in the fourth direction; and
wherein the first distance is substantially equal to a thickness of a rail.

3. The mounting bracket of claim 1, further comprising a gap between the body and the first tab, wherein the gap acts as a hinge to permit the first tab to pivot between the first position and the second position.

4. The mounting bracket of claim 1, further comprising:
a first opening disposed between the inner perimeter and the outer perimeter; and
a second opening disposed between the inner perimeter and the outer perimeter;
wherein the first opening is spaced apart from the second opening; and
wherein the first opening and the second opening are each configured to receive a fastening member.

5. The mounting bracket of claim 1, further comprising:
a first mounting feature disposed along the inner perimeter; and
a second mounting feature disposed along the inner perimeter;
wherein the first mounting feature is spaced apart from the second mounting feature; and
wherein the first mounting feature and the second mounting feature are each configured to receive a fastening member.

6. A mounting system comprising:
an electrical box; and
a mounting plate selectively connected to the electrical box and configured to support the electrical box between a pair of rails, the mounting plate including:
a body having an inner perimeter and an outer perimeter;
a first tab extending from the body in a first direction, the first tab including a first slot configured to receive a first fastener; and
a second tab extending from the body in a second direction opposite the first direction, the second tab including a second slot configured to receive a second fastener;
wherein the first tab and the second tab are each movable relative to the body between a first position and a second position, the first position being substantially parallel to the surface of the body and the second position being substantially perpendicular to the surface of the body.

7. The mounting system of claim 6, wherein the mounting plate further includes:
a first hook offset from the first tab in a third direction perpendicular to the first direction and the second direction; and
a second hook offset from the second tab in the third direction;
wherein the first hook and the first tab are spaced apart by a first distance in a fourth direction that is perpendicular to the first direction and the third direction;
wherein the second hook and the second tab are spaced apart by the first distance in the fourth direction; and
wherein the first distance is substantially equal to a thickness of a rail.

8. The mounting system of claim 6, wherein the mounting plate further includes a gap between the body and the first tab, wherein the gap acts as a hinge to permit the first tab to pivot between the first position and the second position.

9. The mounting system of claim 6, wherein the mounting plate further includes:
a first opening disposed between the inner perimeter and the outer perimeter; and
a second opening disposed between the inner perimeter and the outer perimeter;
wherein the first opening is spaced apart from the second opening; and
wherein the first opening and the second opening are each configured to receive a fastening member.

10. The mounting system of claim 6, wherein the mounting plate further includes:
a first mounting feature disposed along the inner perimeter; and
a second mounting feature disposed along the inner perimeter;
wherein the first mounting feature is spaced apart from the second mounting feature; and
wherein the first mounting feature and the second mounting feature are each configured to receive a fastening member.

11. The mounting system of claim 6, wherein the electrical box is selected from a group of differently-sized electrical boxes, and wherein the mounting plate is configured to connect to any electrical box selected from the group of differently-sized electrical boxes.

12. The mounting system of claim 6, wherein:
the mounting bracket includes a plurality of openings between the outer perimeter and the inner perimeter;
the mounting bracket includes a plurality of mounting features along the inner perimeter;
each of the plurality of openings and the plurality of mounting features are configured to receive a fastener; and
the fastener is received through a selected one of the plurality of openings and the plurality of mounting features based on a size of the electrical box.

13. The mounting system of claim 6, wherein the mounting bracket is configured to connect to the electrical box before connecting to the rails, and wherein the mounting bracket is configured to connect to the rails from behind.

14. A method of mounting an electrical box between a pair of rails, the method comprising:
connecting a mounting plate to the electrical box, the mounting plate including a first edge having a first tab and a first hook, and a second edge having a second tab and a second hook, wherein the first edge is opposite the second edge;
bending the first tab from a first position to a second position substantially perpendicular to the first position;
positioning the mounting plate behind the pair of rails and moving the second edge at least partially through an opening between the pair of rails;
while the second tab and second hook contract one rail of the pair of rails, pivoting the first edge at least partially through the opening; and
moving the first tab to the first position to contact the other rail of the pair of rails.

15. The method of claim 14, further comprising selecting the electrical box from a group of electrical boxes, wherein each electrical box in the group of electrical boxes has a different size.

16. The method of claim 14, wherein:
the mounting bracket includes a plurality of openings between the outer perimeter and the inner perimeter;
the mounting bracket includes a plurality of mounting features along the inner perimeter;
each of the plurality of openings and the plurality of mounting features are configured to receive a fastener; and
positioning the fastener through a selected one of the plurality of openings and the plurality of mounting features based on a size of the electrical box.

17. The method of claim 14, further comprising securing the mounting bracket to the pair of rails by positioning a fastener through a slot in the first tab.

18. The method of claim 14, wherein
the first hook offset from the first tab in a first direction; and
a second hook offset from the second tab in the first direction;
wherein the first hook and the first tab are spaced apart by a first distance in a second direction that is perpendicular to the first direction;
wherein the second hook and the second tab are spaced apart by the first distance in the second direction; and
wherein the first distance is substantially equal to a thickness of a rail of the pair of rails.

19. The method of claim 14, wherein the mounting plate includes a body and a gap between the body and the first tab, wherein the gap acts as a hinge to permit the first tab to pivot between the first position and the second position.

20. The method of claim 14, wherein the first tab in the first position extends radially outwardly from a body of the mounting plate and the first tab in the second extends substantially perpendicular to the body.

21.-31. (canceled)
